(19) United States
(12) Patent Application Publication
(10) Pub. No.: US 2010/0076747 A1
(43) Pub. Date: Mar. 25, 2010

(54) MASS ELECTRONIC QUESTION FILTERING AND ENHANCEMENT SYSTEM FOR AUDIO BROADCASTS AND VOICE CONFERENCES

(75) Inventors: James P. Appleyard, North Richland Hills, TX (US); Keeley L. Weisbard, Frisco, TX (US); Shiju Mathai, Carrollton, TX (US)

Correspondence Address: WOLF GREENFIELD & SACKS, P.C., 600 ATLANTIC AVENUE, BOSTON, MA, 02210-2206, US

(73) Assignee: INTERNATIONAL BUSINESS MACHINES CORPORATION, Armonk, NY (US)

(21) Appl. No.: 12/238,246

(22) Filed: Sep. 25, 2008

(51) Int. Cl. G06F 17/28; G10L 15/26; G06F 17/30

(52) U.S. Cl. 704/3; 704/235; 707/E17.001; 704/E15.001

(57) ABSTRACT

A system for providing electronic filtering and enhancement for audio broadcasts and voice conferences. The system can comprise one or more computing devices configured to record one or more spoken segments, wherein the one or more spoken segments are comprised of utterances. The system can also include one or more electronic data processors configured to process, manage, and store the one or more spoken segments and data, wherein the at least one electronic data processor is communicatively linked to the one or more computing devices. The system can further include a speech-to-text module configured to execute on the one or more electronic data processors, wherein the speech-to-text module converts the one or more spoken segments into a plurality of text segments. Additionally, the system can include a database module configured to execute on the one or more electronic data processors, wherein the database module stores the plurality of text segments in a queue. The system can also include a filtration-prioritization module configured to execute on the one or more electronic data processors, wherein the filtration-prioritization module is configured to filter one or more text segments of the plurality of text segments in the queue, wherein the utterances to be filtered arc defined in advance of filtering. The filtration-prioritization module can also be configured to determine a relevance of the one or more text segments. The filtration-prioritization module can be further configured to prioritize the one or more text segments based upon one or more of the relevance and a similarity of the one or more text segments to other text segments of the plurality of text segments in the queue. Moreover, the filtration-prioritization module can be configured to transmit the one or more text segments to a presenter.

### FIELD OF THE INVENTION

The present invention is related to the fields of data processing, conferencing, and input technologies, and more particularly, to techniques for electronic filtering and enhancement that are particularly suited for enabling effective question-and-answer sessions.

### BACKGROUND OF THE INVENTION

With the ever-increasing popularity and expanding use of audio broadcasting and voice conferencing technologies, there has been a corresponding rise in the demand for greater efficiency and quality of such technologies. Currently, there is no effective process to filter or enhance questions, dialogue, and other speech coming from audiences participating in today's audio broadcasts or voice conferences.

As a result, present day technologies do not adequately address the multitude of issues pertaining to the effective interaction between various users participating in broadcasts or conferences. For example, a typical question-and-answer session often entails having to deal with irrelevant questions, a multitude of duplicative questions or statements, inappropriate language, users who speak different languages, and significant delays in communication. It is thus often difficult, particularly in professional contexts, to ensure a high level of satisfaction in such broadcasts and conferences where speed and quality are of the utmost importance. Current conventional technologies typically only present users with the option of either rapid communication with sub-optimal quality or optimal quality with sub-optimal communication speeds.

As a result, there is a need for more efficient and effective systems for enabling electronic filtering and enhancement for audio broadcasts and conferences, while simultaneously facilitating an optimal user experience.

### SUMMARY OF THE INVENTION

The present invention is directed to systems and methods for providing electronic filtering and enhancement for audio broadcasts and voice conferences. A tool utilizing the following, methods can enable efficient and effective filtering and enhancement of various types of utterances including, but not limited to, words, phrases, and sounds. Such an approach is particularly useful in saving significant time and increasing the quality of question-and-answer sessions, audio broadcasts, voice conferences, and other voice-related events.

One embodiment of the invention is a system for providing electronic filtering and enhancement for audio broadcasts and voice conferences. The system can comprise one or more computing devices configured to record one or more spoken segments, wherein the one or more spoken segments are comprised of utterances. The system can also include one or more electronic data processors configured to process, manage, and store the one or more spoken segments and data, wherein the at least one electronic data processor is communicatively linked to the one or more computing devices. The system can further include a speech-to-text module configured to execute on the one or more electronic data processors, wherein the speech-to-text module converts the one or more spoken segments into a plurality of text segments. Additionally, the system can include a database module configured to execute on the one or more electronic data processors, wherein the database module stores the plurality of text segments in a queue. The system can also include a filtration-prioritization module configured to execute on the one or more electronic data processors, wherein the filtration-prioritization module is configured to filter one or more text segments of the plurality of text segments in the queue, wherein the utterances to be filtered are defined in advance of filtering. The filtration-prioritization module can also be configured to determine a relevance of the one or more text segments. The filtration-prioritization module can be further configured to prioritize the one or more text segments based upon one or more of the relevance and a similarity of the one or more text segments to other text segments of the plurality of text segments in the queue. Moreover, the filtration-prioritization module can be configured to transmit the one or more text segments to a presenter.

Another embodiment of the invention is a computer-based method for providing electronic filtering and enhancement in a system for audio broadcasts and voice conferences. The method can include recording one or more spoken segments, wherein the one or more spoken segments are comprised of utterances. The method can also include converting the one or more spoken segments into a plurality of text segments and storing the plurality of text segments in a queue. Additionally, the method can include filtering one or more text segments of the plurality of text segments in the queue, wherein the utterances to be filtered are defined in advance of filtering. The method can further include prioritizing the one or more text segments based upon one or more of a relevance of the one or more text segments and a similarity of the one or more text segments to other text segments of the plurality of text segments in the queue. Furthermore, the method can include transmitting the one or more text segments to a presenter.

Yet another embodiment of the invention is a computer-readable storage medium that contains computer-readable code, which when loaded on a computer, causes the computer to perform the following steps: recording one or more spoken segments, wherein the one or more spoken segments are comprised of utterances; converting, the one or more spoken segments into a plurality of text segments and storing the plurality of text segments in a queue; filtering one or more text segments of the plurality of text segments in the queue, wherein the utterances to be filtered are defined in advance of filtering; determining a relevance of the one or more text segments; determining a similarity of the one or more text segments to other text segments of the plurality of text segments in the queue; prioritizing the one or more text segments based upon one or more of the determined relevance and the determined similarity; and, transmitting the one or more text segments to a presenter.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system for providing electronic filtering and enhancement for audio broadcasts and voice conferences, according to one embodiment of the invention.

FIG. 2 is a schematic view of the data flow through select components of the system.

FIG. 3 is a flow diagram illustrating one embodiment of the system for providing electronic filtering and enhancement for audio broadcasts and voice conferences.

FIG. 4 is another embodiment of a system for providing electronic filtering and enhancement.

FIG. 5 is a flowchart of steps in a method for providing electronic filtering and enhancement for audio broadcasts and voice conferences, according to another embodiment of the invention.

### DETAILED DESCRIPTION

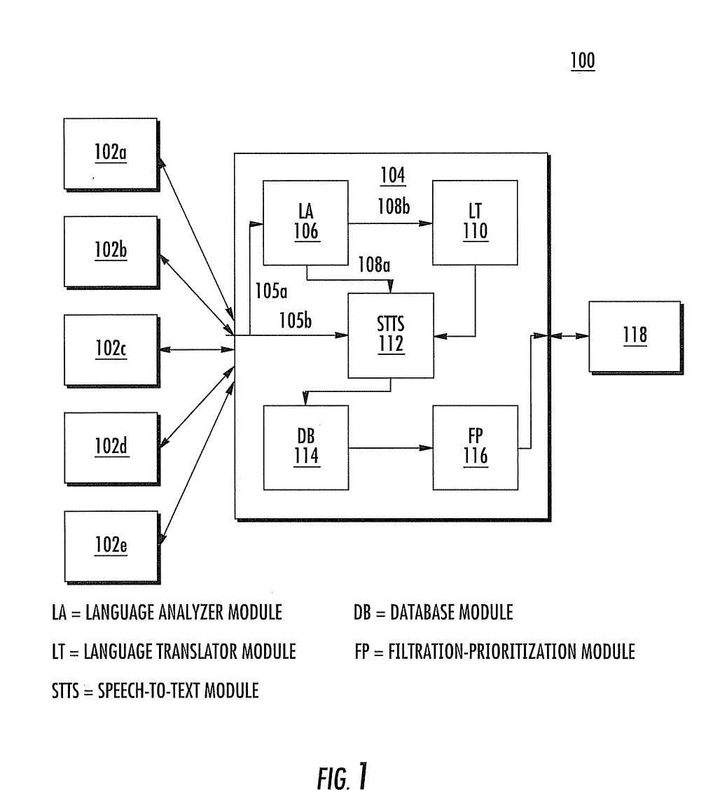

Referring initially to FIG. 1, a system 100 for providing electronic filtering and enhancement for audio broadcasts and voice conferences is schematically illustrated. The system 100 can include one or more computing devices 102a-e. Also, the system 100 can include one or more electronic data processors 104 communicatively linked to the one or more computing devices 102a-e. Although five computing devices 102a-e and one electronic data processor 104 are shown, it will be apparent to one of ordinary skill based on the description that a greater or fewer number of computing devices 102a-e and a greater number of electronic data processors 104 can be utilized.

The system 100 can further include a series of modules including, but not limited to, a language analyzer module 106, a language translator module 111, a speech-to-text module 112, a database module 114, and a filtration-prioritization module 116, which can be implemented as computer-readable code configured to execute on the one or more electronic data processors 104. Alternatively, the modules 106, 110, 112, 114, and 116 can be implemented in hardwired, dedicated circuitry for performing the operative functions described herein. In another embodiment, however, the modules 106, 110, 112, 114, and 116 can be implemented in a combination of hardwired circuitry and computer-readable code. In yet another embodiment, the modules 106, 110, 112, 114, and 116 can implemented collectively as one module or as multiple modules.

Operatively, according to one embodiment, a user can utilize the one or more computing devices 102a-e to record one or more spoken segments, wherein the one or more spoken segments are comprised of utterances. For example, the user can speak into a microphone embedded within a computer and the computer can record any utterances such as sounds, words, or phrases that the user makes. From here, the one or more spoken segments are sent to the one or more electronic data processors 104, which, in this embodiment, are also known as a Central Voice Podcast Server (CVPS). The one or more electronic data processors 104 are configured to process, manage, and store the one or more spoken segments and data. The speech-to-text module 112, which is configured to execute on the one or more electronic data processors 104, can receive the one or more spoken segments via path 105b and convert the one or more spoken segments into a plurality of text segments.

After the spoken segments are converted, the database module 114, which is configured to execute on the one or more electronic data processors 104, stores the plurality of text segments in a queue. The database module 114 can store the plurality of segments in a first-in-first-out order, but it is not necessarily required to do so. The plurality of text segments are then transmitted to the filtration-prioritization (FP) module 116, which is also configured to execute on the one or more electronic data processors 104. The FP module 116 can be configured to filter one or more text segments of the plurality of text segments in the queue, wherein the utterances to be filtered are defined in advance of the filtering. For example, the FP module 116 can be set to filter out language deemed to be inappropriate coming from users or retain language deemed to be useful. The FP module 116 cain also be configured to determine a relevance of the one or more text segments. The relevance can indicate, but is not limited to, the likelihood that the one or more text segments relate to a particular topic of a presenter 118 or that the one or more text segments is not relevant.

Furthermore, the FP module 116 can be configured to prioritize the one or more text segments based upon their relevance. For example, if a particular text segment is relevant to the presenter's 118 topic, that text segment can be moved higher up in the queue so as to be delivered sooner to the presenter 118. The FP module 116 can also be configured to prioritize the one or more text segments based on a similarity of the one or more text segments to other text segments of the plurality of text segments in the queue. As an illustration, if one user asks the question “What is the probability that more people will buy product X?” and another user asks the question “What is the chance that more people will buy product X?” the FP module 116 call prioritize the questions higher in the queue. The FP module 116 can be further configured to transmit the one or more text segments to the presenter 118. It is important note that the processing in the system 100, via the CVPS, can flow not only from users to a presenter 118, but also from the presenter 118 to the users.

According to one embodiment, the one or more spoken segments can be associated with a topic of the presenter 118. The relevance of the one or more spoken segments can be determined by correlating the one or more text segments with the topic. In another embodiment, the recording of the one or more spoken segments can be initiated by pressing a key on the one or more computing devices 102a-e and terminated by pressing the key again. Also, the one or more spoken segments can be disassociated from a particular user who is making the one or more spoken segments. This enables users to record their spoken segments, while maintaining their anonymity.

In another embodiment of the system 100, the system 100 utilizes the language analyzer (LA) module 106, wherein the LA module 106 is configured to determine a language of the presenter 118. Additionally, the LA module 106 can be further configured to analyze the one or more spoken segments, which are transmitted to the LA module 106 via path 105a. During the analysis, the LA module 106 can determine if the one or more spoken segments is in the determined language of the presenter 118. For example, the LA module 106 might find that a particular user speaks English and that this user's language matches the presenter's language of English. If the LA module 106 finds that the one or more spoken segments are in the determined language of the presenter, the segments can be sent directly via path 108a to the speech-to-text module 112 for conversion.

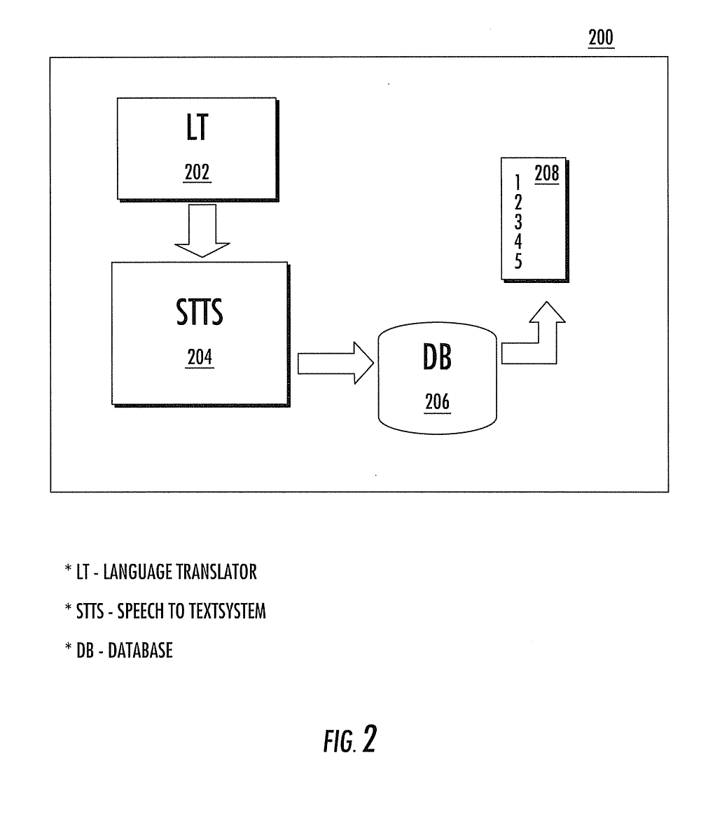

If, however, the LA module 106 determines that a particular user's one or more spoken segments is in a language different from that of the presenter's, the system can send the one or more spoken segments to the language translator (LT) module 110 via path 108b. The LT module 110 can be configured to translate the one or more spoken segments to the determined language of the presenter 118. From here, the one or more spoken segments can be sent to the speech-to-text module 112 for conversion into a plurality of text segments. As mentioned above, the plurality of text segments are then stored in a queue through the database module 114 and then transmitted to the FP module 116 for further processing. Referring now also to FIG. 2, a schematic view 200 of the data flow through select components in the system 100 is illustrated. The view 200 includes a language translator (LT) 202, which translates the one or more spoken segments from a user. The one or more spoken segments is then transmitted to a speech-to-text module (STTS) 204 for conversion into text. After conversion, the text is transmitted to a database 206 for storage and then to a moderator or presenter as a list of ordered text segments 208.

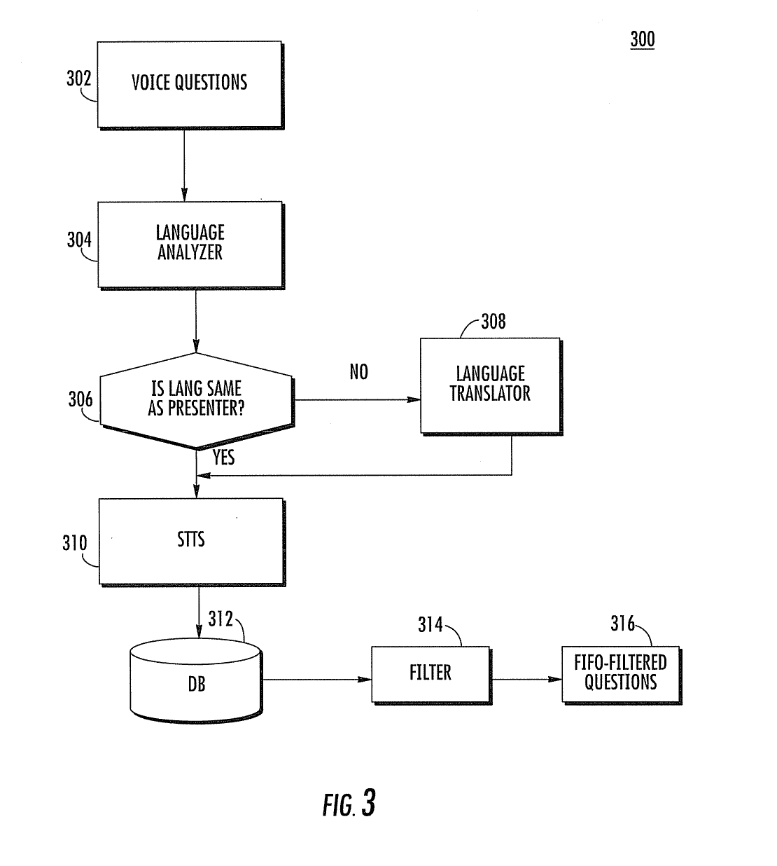

Referring now also to FIG. 3, a flow diagram 300 depicting the data flow in one embodiment of the system 100 for providing electronic filtering and enhancement for audio broadcasts and voice conferences is shown. The diagram 300 illustrates voice questions 302 coming from users, which can then be transmitted to the language analyzer (LA) 304 for analysis. In this embodiment, the LA 304 can check to see if the language of the voice questions 302 is in the same language as the presenter 118. If the voice questions 302 are in the same language as the presenter, then the voice questions 302 can be transmitted to the speech-to-text module 310 for conversion into text. On the other hand, if the voice questions 302 are not in the same language as the presenter, then the voice questions can be transmitted to the language translator (LT) 308 for translation and then to the speech-to-text system (module) 310 for conversion. Once the voice questions 302 are converted, they can be sent to the database 312 for storage. The filter 314 can then filter and prioritize the voice questions 302 and deliver them to a moderator or presenter via a first-in-first-out queue 316.

In another embodiment, the FP module 116 can be configured to exclude other text segments of the plurality of text segments similar to the one or more text segments in the queue. For example, if one user asks “What is the number of processors in the device?” and another user asks “How many processors are in the device?,” the FP module can exclude one of the questions from the queue and retain the remaining, question. If the one or more text segments had similar other text segments excluded, the FP module 116 can add a bonus score to the one or more remaining text segments, wherein the bonus score can correspond to the quantity of similar other text segments excluded from the queue. Additionally, the one or more text segments with a bonus score can be prioritized higher in the queue.

According to one embodiment, the FP module 116 can filter the one or more text segments using a keyword, wherein the keyword is matched to an utterance contained within the one or more text segments. The matching of a keyword to one or more text segments can enable the FP module 116 to perform one or more of excluding and including the utterance from the one or more text segments. As an illustration, if a keyword is set to be the word “processor,” and the FP module 116 finds one or more text segments including the word “processor,” then the one or more text segments containing the word “processor” can either be excluded, included, or prioritized. The keyword can also be assigned a weight, wherein the weight indicates the relevance of the particular keyword. For example, if a particular discussion is about “processors” and the weights for a particular keyword range from 1 to 100, then the keyword “processor” as it pertains to the discussion might have a value of 99.

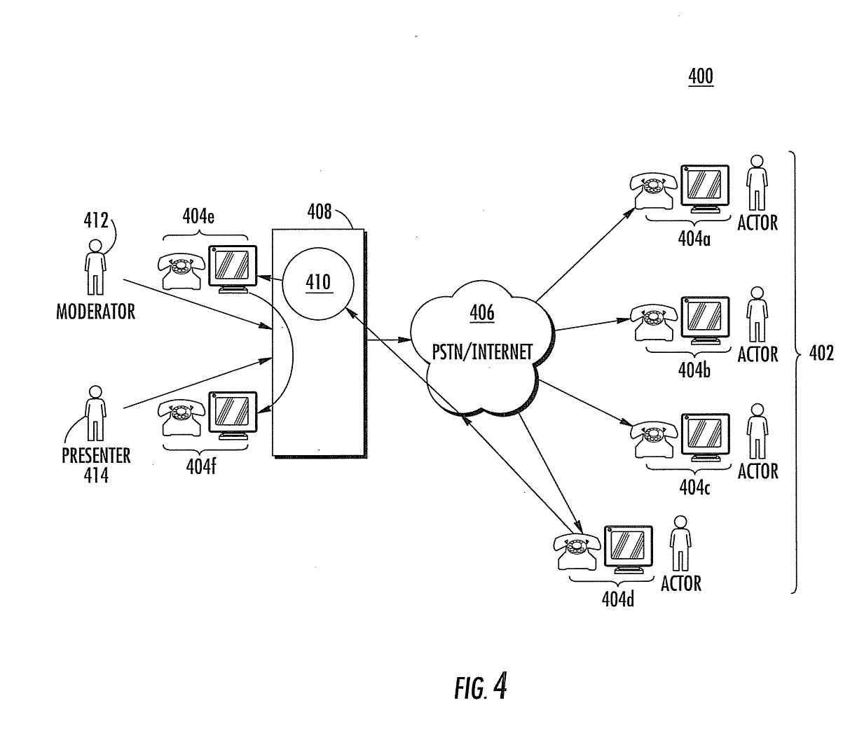

In yet another embodiment, the filtering and prioritizing can be performed by a moderator. Also, the moderator can edit the one or more text segments and deliver the one or more text segments to the presenter 118. Referring now also to FIG. 4, another embodiment of a system 400 for providing electronic filtering and enhancement is illustrated. The system 400 can include actors or users 402 who utilize one or more computing devices 404a-d configured to record and send one or more spoken segments. Once the one or more spoken segments are recorded they can be transmitted to the Central Voice Podcast Server (CVPS) 408, which can contain one or more electronic data processors 104 via the Internet or through a public switched telephone network (PTSN) 406. The CVPS 408 can include a module 410 comprised of the aforementioned modules 106, 110, 112, 114, and 116. Once the one or more spoken segments are processed and converted by the CVPS 408 they can be transmitted to a computing device 404c so as to enable a moderator 412 to access the one or more converted text segments. From here, the moderator can perform the filtration and prioritization and can edit the one or more text segments via the CVPS 408. The moderator 412 can then use the CVPS 408 to send the one or more text segments to a computing device 404f, where a presenter 414 can view the one or more text segments and interact with moderator 412 and users 402 in a discussion. It is important to note that spoken segments can be captured and processed from any of the above mentioned parties to any of the other parties.

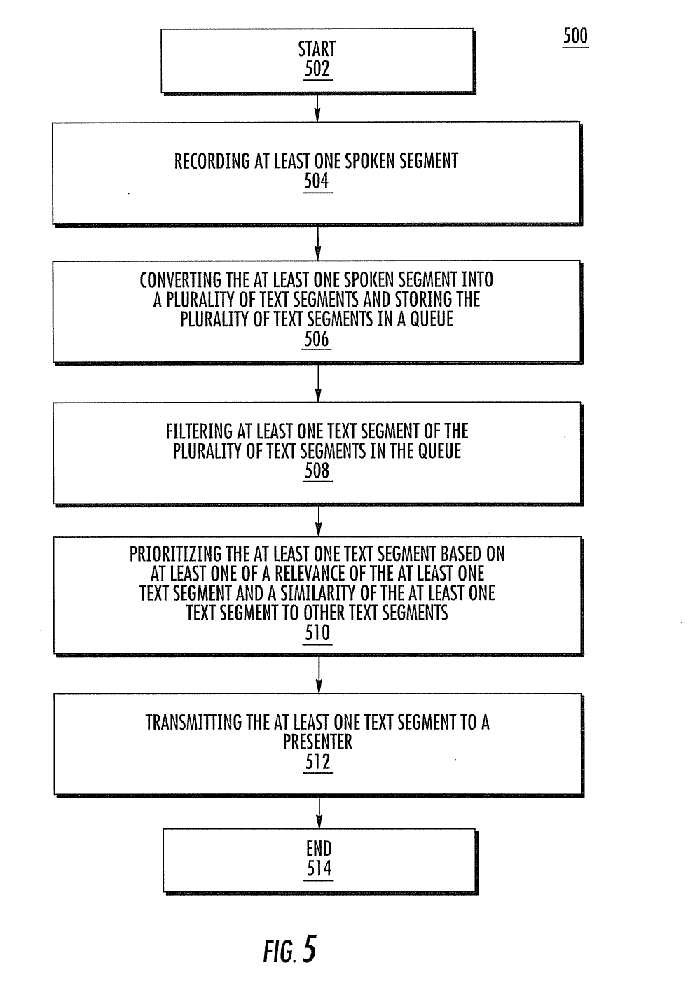

Referring now to FIG. 5 a flowchart is provided that illustrates certain method aspects of the invention. The flowchart depicts steps of a method 500 for providing electronic filtering and enhancement in a system for audio broadcasts and voice conferences. The method 500 illustratively can include, after the start step 502, recording one or more spoken segments, wherein the one or more spoken segments are comprised of utterances, at step 504. The method 500 can also include converting the one or more spoken segments into a plurality of text segments and storing the plurality of text segments in a queue at step 506. At step 508, the method 500 can further include filtering one or more text segments of the plurality of text segments in the queue, wherein the utterances to be filtered are defined in advance of filtering. Furthermore, the method 500 can include prioritizing the one or more text segments based upon one or more of a relevance of the at least one text segment and a similarity of the one or more text segments to other text segments of the plurality of text segments in the queue at step 510. Moreover, at step 512, the method 500 can include transmitting the one or more text segments segment to a presenter. The method 500 illustratively concludes at step 514.

According to one embodiment, the one or more spoken segments can be associated with a topic of the presenter. The method 500 can also include determining the relevance based upon a correlation of the one or more text segments with the topic of the presenter. Additionally, the method 500 can further include, at the recording step 504, initiating the recording of the one or more spoken segments by pressing a keys on a device and terminating the recording by pressing the key again. The one or more recorded spoken segments can also be disassociated from a particular user making the one or more spoken segments.

In another embodiment, the method 500 can comprise determining a language of the presenter. The method 500 can also include analyzing the one or more spoken segments to determine if the one or more spoken segments is in the determined language of the presenter. The method 500 can further include translating the one or more spoken segments to the determined language of the presenter if the one or more spoken segments is determined to be in a language different from the determined language of the presenter.

In yet another embodiment, the method 500 include, at the filtering step 508, excluding other text segments of the plurality of text segments which are similar to the one or more text segments in the queue. Additionally, the method 500 can comprise adding a bonus score to the one or more text segments which had similar other text segments excluded. The bonus score can correspond to the quantity of similar other text segments excluded and can enable the one or more text segments to be prioritized higher in the queue.

According to another embodiment, the method 500 can include, at the filtering step 508, filtering the one or more text segments using a keyword. The keyword can be matched to an utterance contained within the one or more text segments and can be used to perform one Or more of excluding, including, and prioritizing the one or more text segments. The keyword can also be assigned a weight, which can indicate the relevance of the particular keyword.

In yet another embodiment, the method 500 can include enabling a moderator to perform the filtering and prioritizing steps. The moderator can also edit the one or more text segments and deliver the one or more text segments to the presenter.

The invention, as already mentioned, can be realized in hardware, software, or a combination of hardware and software. The invention can be realized in a centralized fashion in one computer system, or in a distributed fashion where different elements are spread across several interconnected computer systems. Any type of computer system or other apparatus adapted for carrying out the methods described herein is suitable. A typical combination of hardware and software can be a general purpose computer system with a computer program that, when being loaded and executed, controls the computer system such that it carries out the methods described herein.

The invention, as already mentioned, can be embedded in a computer program product, such as magnetic tape, an optically readable disk, or other computer-readable medium for storing electronic data. The computer program product can comprise computer-readable code, defining a computer program, which when loaded in a computer or computer system causes the computer or computer system to carry out the different methods described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The preceding description of preferred embodiments of the invention have been presented for the purposes of illustration. The description provided is not intended to limit the invention to the particular forms disclosed or described. Modifications and variations will be readily apparent from the preceding description. As a result, it is intended that the scope of the invention not be limited by the detailed description provided herein.

We claim:

1. A computer-based method for providing electronic filtering and enhancement in a system for audio broadcasts and voice conferences the method comprising:
recording at least one spoken segment, wherein the at least one spoken segment is comprised of utterances;
converting the at least one spoken segment into a plurality of text segments and storing the plurality of text segments in a queue;
filtering at least one text segment of the plurality of text segments in the queue wherein the utterances to be filtered are defined in advance of filtering;
prioritizing the at least one text segment based upon at least one of a relevance of the at least one text segment and a similarity of the at least one text segment to other text segments of the plurality of text segments in the queue; and
transmitting the at least one text segment to a presenter.

2. The method of claim 1, wherein the at least one spoken segment is associated with a topic of the presenter and further comprising determining the relevance based on a correlation of the at least one text segment with the topic.

3. The method of claim 1, wherein the recording of the at least one spoken segment can be initiated by pressing a key on a device and terminated by pressing the key again and wherein the at least one spoken segment is disassociated from a particular user making the at least one spoken segment.

4. The method of claim 1, further comprising determining a language of the presenter.

5. The method of claim 4, further comprising analyzing the at least one spoken segment to determine if the at least one spoken segment is in the determined language of the presenter.

6. The method of claim 5, further comprising translating the at least one spoken segment to the determined language of the presenter if the at least one spoken segment is determined to be in a language different from the determined language of the presenter.

7. The method of claim 1, wherein the filtering step comprises excluding other text segments of the plurality of text segments similar to the at least one text segment in the queue.

8. The method of claim 7, further comprising adding a bonus score to the at least one text segment which had similar other text segments excluded, wherein the bonus score corresponds to the quantity of similar other text segments excluded and enables the at least one text segment to be prioritized higher in the queue.

9. The method of claim 1, further comprising filtering the at least one text segment using a keyword, wherein the keyword is matched to an utterance contained within the at least one text segment and can be used to perform at least one of excluding, including, and prioritizing the at least one text segment.

10. The method of claim 9, wherein the keyword can be assigned a weight, wherein the weight indicates the relevance of the particular keyword.

11. The method of claim 1, wherein the filtering and prioritizing steps are performed by a moderator.

12. The method of claim 11, wherein the moderator can edit the at least one text segment and deliver the at least one text segment to the presenter.

13. A computer-based system for providing electronic filtering and enhancement for audio broadcasts and voice conferences, the system comprising:
at least one computing device configured to record at least one spoken segment, wherein the at least one spoken segment is comprised of utterances:
at least one electronic data processor configured to process, manage, and store the at least one spoken segment and data, wherein the at least one electronic data processor is communicatively linked to the at least one computing device;
a speech-to-text module configured to execute on the at least one electronic data processor, wherein the speech-to-text module converts the at least one spoken segment into a plurality of text segments;
a database module configured to execute on the at least one electronic data processor, wherein the database module stores the plurality of text segments in a queue;
a filtration-prioritization module configured to execute on the at least one electronic data processor, wherein the filtration-prioritization module is configured to:
filter at least one text segment of the plurality of text segments in the queue, wherein the utterances to be filtered are defined in advance of filtering;
determine a relevance of the at least one text segment;
prioritize the at least one text segment based upon at least one of the relevance and a similarity of the at least one text segment to other text segments of the plurality of text segments in the queue; and
transmit the at least one text segment to a presenter.

14. The system of claim 13, wherein the at least one spoken segment is associated with a topic of the presenter and further comprising determining the relevance based on a correlation of the at least one text segment with the topic.

15. The system of claim 13, wherein the recording of the at least one spoken segment can be initiated by pressing a key on the at least one computing device and terminated by pressing the key again and wherein the at least one spoken segment can be disassociated from a particular user making the at least one spoken segment.

16. The system of claim 13, further comprising a language analyzer module configured to execute on the at least one electronic data processor, wherein the language analyzer module is configured to determine a language of the presenter.

17. The system of claim 16, wherein the language analyzer module is further configured to analyze the at least one spoken segment to determine if the at least one spoken segment is in the determined language of the presenter.

18. The system of claim 17, further comprising a language translator module configured to execute on the at least one electronic data processor, wherein the language translator module is configured to translate the at least one spoken segment to the determined language of the presenter if the at least one spoken segment is determined to be in a language different from the determined language of the presenter.

19. The system of claim 13, wherein the filtration-prioritization module excludes other text segments of the plurality of text segments similar to the at least one text segment in the queue.

20. The system of claim 19, further comprising adding a bonus score to the at least one text segment which had similar other text segments excluded, wherein the bonus score corresponds to the quantity of similar other text segments excluded and enables the at least one text segment to be prioritized higher in the queue.

21. The system of claim 13, wherein the filtration-prioritization module filters the at least one text segment using a keyword, wherein the keyword is matched to an utterance contained within the at least one text segment and can be used to perform at least one of excluding, including, and prioritizing the at least one text segment.

22. The system of claim 21, wherein the keyword can be assigned a weight, wherein the weight indicates the relevance of the particular keyword.

23. The system of claim 13, wherein the filtering and prioritizing are performed by a moderator.

24. The system of claim 23, wherein the moderator can edit the at least one text segment and deliver the at least one text segment to the presenter.

25. A computer-readable storage medium having stored therein computer-readable instructions, which, when loaded in and executed by a computer causes the computer to perform the steps of:
recording at least one spoken segment, wherein the at least one spoken segment is comprised of utterances;
converting the at least one spoken segment into a plurality of text segments and storing the plurality of text segments in a queue;
filtering at least one text segment of the plurality of text segments in the queue, wherein the utterances to be filtered are defined in advance of filtering;
determining a relevance of the at least one text segment;
determining a similarity of the at least one text segment to other text segments of the plurality of text segments in the queue;
prioritizing the at least one text segment based upon at least one of the determined relevance and the determined similarity; and
transmitting the at least one text segment to a presenter.

26. The computer-readable storage medium of claim 25, wherein the at least one spoken segment is associated with a topic of the presenter and further comprising determining the relevance based on a correlation of the at least one text segment with the topic.

27. The computer-readable storage medium of claim 25, wherein the recording step, the recording of the at least one spoken segment can be initiated by pressing a key on a device and terminated by pressing the key again and wherein the at least one spoken segment can be disassociated from a particular user making the at least one spoken segment.

28. The computer-readable storage medium of claim 25, further comprising computer-readable code for causing the computer to determine a language of the presenter.

29. The computer-readable storage medium of claim 28, further comprising computer-readable code for causing the computer to analyze the at least one spoken segment to determine if the at least one spoken segment is in the determined language of the presenter.

30. The computer-readable storage medium of claim 29, further comprising computer-readable code for causing the computer to translate the at least one spoken segment to the determined language of the presenter if the at least one spoken segment is determined to be in a language different from the determined language of the presenter.

31. The computer-readable storage medium of claim 25, wherein the filtering step comprises excluding other text segments of the plurality of text segments similar to the at least one text segment in the queue.

32. The computer-readable storage medium of claim 31, further comprising computer-readable code for causing the computer to add a bonus score to the at least one text segment which had similar other text segments excluded, wherein the bonus score corresponds to the quantity of similar other text segments excluded and enables the at least one text segment to be prioritized higher in the queue.

33. The computer-readable storage medium of claim 25, wherein the filtering step comprises filtering the at least one text segment using a keyword, wherein the keyword is matched to an utterance contained within the at least one text segment and can be used to perform at least one of excluding, including, and prioritizing the at least one text segment.

34. The computer-readable storage medium of claim 33, wherein the keyword can be assigned a weight, wherein the weight indicates the relevance of the particular keyword.

35. The computer-readable storage medium of claim 25, wherein the filtering and prioritizing steps are performed by a moderator and wherein the moderator can edit the at least one text segment and deliver the at least one text segment to the presenter.
